(19) United States
(12) Patent Application Publication
(10) Pub. No.: US 2025/0370408 A1
(43) Pub. Date: Dec. 4, 2025

(54) OPTICAL ELEMENT REPLICATING METHOD

(71) Applicant: ams lnternational AG, Jona (CH)

(72) Inventors: Frédéric MONTFORT, Froideville (CH); Robin KAECH, Lausanne (CH)

(21) Appl. No.: 18/714,347

(22) PCT Filed: Nov. 7, 2022
(86) PCT No.: PCT/EP2022/080994

§ 371 Date: May 29, 2024

(30) Foreign Application Priority Data
Nov. 30, 2021 (GB) 2117270.5

(51) Int. Cl. G03H 1/20; G03H 1/02; G03H 1/04; G03H 1/22

(52) U.S. Cl. CPC G03H 1/20; G03H 1/0486; G03H 1/2202; G03H 1/0248

(57) ABSTRACT

A method includes illuminating a first optical element with an illumination beam to generate a beam of interest and noise from the first optical element. The first optical element is a master copy to be replicated. The method also includes recording in a first recording medium an interference pattern between the beam of interest and a reference beam. The first recording medium is positioned in an optical path of the beam of interest and outside an optical path of the noise. The method further includes illuminating the recorded interference pattern in the first recording medium with a conjugate of the reference beam to generate a conjugate of the beam of interest. The method additionally includes replicating the first optical element in a second recording medium by recording in the second recording medium an interference pattern between the conjugate of the beam of interest and a conjugate of the illumination beam.

### FIELD

The present disclosure relates to a method of replicating an optical element.

### BACKGROUND

Volume phase holographic (VPH) gratings are a type of diffraction grating in which a photosensitive recording medium (such as a photopolymer) is exposed to a holographic interference pattern and subsequently developed.

Replicating VPH gratings from a master copy consists of laminating a layer of fresh recording medium onto a surface of the master copy, and exposing it to the interference pattern created by two beams: the first beam illuminating the master copy, the second beam being the one generated by the master copy during the illumination which interferes with the illuminating beam. The recording medium reacts to being exposed to the interference pattern which is thereby recorded into the recording medium. The recording medium can then be developed and removed from the surface of the master copy, resulting in a VPH grating which is a replication of the master copy.

However, the illumination of the master copy not only generates the desired beam but also several other unwanted beams caused by different diffraction orders, parasitic reflections and other unwanted scattering. These other unwanted beams inevitably also end up forming part of the interference pattern when they interfere with the illumination beam as well as with themselves. These unwanted interference patterns are inevitably recorded in the recording medium and thereby end up in the replicated VPH grating causing undesired noise and effects in the replicated VPH's optical function. Thus the replicated VPH grating is a noisy copy of the master.

U.S. Pat. No. 10,359,736 B2 proposes a method of producing holograms from a master.

The same problems occur when replicating masters of other optical elements such as refractive optics (for example, diffusers), mirrors, diffractive optical elements (for example, surface relief gratings, metasurfaces, and polarization gratings). In particular, diffractive optical elements such as surface relief gratings, metasurfaces and polarization gratings are able to modify an incident beam of light into a wide variety of different shapes. However, this ability has the drawback during replication that incident light is split into many beams of which most are noise.

An improved method of replicating optical elements from master copies is desired.

### SUMMARY

In general terms the present disclosure overcomes the above and other problems by using an intermediate recording medium to isolate the beam of interest of a master from the unwanted beams caused by different diffraction orders, parasitic reflections and other unwanted scattering, also referred to herein as noise. This is achieved by ensuring the intermediate recording medium does not intersect any of the unwanted beams, for example by spatially positioning it out of and away from the optical path of such beams.

Once the noise-free, isolated beam of interest is recorded in the intermediate recording medium, it can be read out from the intermediate recording medium and projected onto the target recording medium in which the master is being replicated. The final result is a noise-free, replicated master.

The master may be a copy of any optical element where a beam of interest is to be isolated from noise including, for example, volume phase holographic (VPH) gratings, elements such as refractive optics (for example, diffusers), mirrors, diffractive optical elements (for example, surface relief gratings, metasurfaces for example, metalenses, polarization gratings, and/or any combination thereof).

Thus, according to a first aspect of the present disclosure, there is provided a method of replicating an optical element, the method comprising: illuminating a first optical element with an illumination beam to generate a beam of interest and noise from the first optical element, the first optical element being a master copy to be replicated; recording in a first recording medium an interference pattern between the beam of interest and a reference beam; illuminating the recorded interference pattern in the first recording medium with a conjugate of the reference beam to generate a conjugate of the beam of interest; and replicating the first optical element in a second recording medium by recording in the second recording medium an interference pattern between the conjugate of the beam of interest and a conjugate of the illumination beam.

Advantageously, the method of the present disclosure is made possible by the use of conjugate beams i.e. beams having a reversed or opposite propagation direction but with the same amplitudes, wavelengths and phases to (i) read out the first recording medium to produce a conjugate of the beam of interest and (ii) replicate the master copy of the first optical element by using an interference pattern between a conjugate of the illumination beam and the conjugate of the beam of interest.

As will be appreciated, the intermediate recording medium (i.e. the first recording medium) and target recording medium (i.e. the second recording medium) may comprise a photosensitive recording material such as a photopolymer or any other photosensitive recording material known to the skilled person in which a hologram may be recorded. Thus, a hologram in the intermediate recording medium comprises a recording of the above described interference pattern between the reference beam and the beam of interest and a hologram recorded in the target recording medium comprises a recording of the above described interference pattern between the conjugate beam of interest and the conjugate of the illumination beam.

Optionally, the first optical element comprises a diffractive optical element, for example a metasurface or polarisation grating.

Advantageously, as described above, these types of optical element are able to modify an incident beam of light into a wide variety of different shapes and are accordingly have many uses. However, this ability has the drawback during replication that incident light is split into many beams of which most are noise and which make producing perfect replicas of masters difficult. The inventors have surprisingly found that, whilst the present method is effective at replicating any optical element with reduced noise, the present method is particularly effective at replicating diffractive optical elements, for example surface relief gratings, metasurfaces, polarisation gratings and/or other diffractive optical elements as these often produce many noise beams when illuminated during the replication process.

Optionally, the method comprises positioning the first recording medium in an optical path of the beam of interest and outside any optical path of the noise.

Advantageously, this spatial separation ensures the noise does not get recorded in the first recording medium whereas the beam of interest does. In this way, the beam of interest is isolated from the noise and can be used to replicate the first optical element in a noise-free manner.

Optionally, illuminating the first optical element and the recording of the interference pattern in the first recording medium are performed in a first step, and illuminating the recorded interference pattern in the first recording medium and replicating the first optical element in the second recording medium are performed in a second step.

Optionally, the method further comprises positioning the first optical element at a first position during said illumination by the illumination beam; and positioning the second recording medium at the first position during said illumination by the conjugate of the illumination beam

Advantageously, splitting the method into two, chronological steps allows the first optical element to be moved out of the way from a first position and the second recording medium positioned there instead. This ensures that when the noise-free recording in the first recording medium is read out and projected back onto the second recording medium, the positioning of the second recording medium accurately matches that of the first optical element so that the replication is identical or close to identical.

Optionally, the method comprises providing the first optical element, the first recording medium, and the second recording medium on one or more surfaces of a propagation medium having a refractive index different to free space, for example glass.

Optionally, said illumination beam and said conjugate of the reference beam illuminate the first optical element and the first recording medium respectively by propagation through the propagation medium.

Optionally, said reference beam and said conjugate of the illumination beam illuminate the first and the second recording medium respectively without propagation through the propagation medium.

Advantageously, full or partial propagation in a propagating medium such as a glass block allows the method to be used to replicate masters whose read out or illumination is intended to be launched or received into or from total internal reflection in such a medium, for example, in combiner elements of AR or VR heads up displays. Thus, it is not necessary to simulate such operation in the illumination or reference beams during recording as the glass propagation medium ensures this is implicitly recorded into the system during replication. Further, it provides a greater degree of flexibility of positioning of the first optical element, the first recording medium and the second recording medium relative to each other as the illumination beam, beam of interest, reference beam, and their conjugates can be guided through the glass propagation medium through total internal reflection from anywhere.

Optionally, the illumination beam, the reference beam, the beam of interest, and the conjugates thereof each comprise a plurality of beams of different wavelengths.

Optionally, additionally or alternatively, each of the plurality of beams has a different angle of incidence on the first optical element, first recording medium, or second recording medium as applicable.

Optionally, illumination by said plurality of beams is provided simultaneously or sequentially.

Optionally, the first recording medium comprises a plurality of recording areas each positioned to intersect one or more of the plurality of beams of different wavelength and/or angle of incidence of the beam of interest.

Advantageously, this allows the replicating process to be multiplexed with different wavelengths and/or angles at the same time. For example, the main master (i.e. the first optical element) can be illuminated with multiple beams having different angles of incidence and/or wavelengths simultaneously or sequentially. The beam of interest diffracted by the main master (accordingly also made up of corresponding multiple beams of different wavelength and/or angle) may optionally overlap and the first recording medium may be made up of several intermediate recording media or masters (i.e. referred to herein as recording areas) placed at spatially different positions to intersect with a corresponding beam of interest of a corresponding different wavelength and/or colour and with a corresponding one of a number of reference beams to generate the recorded interference pattern. The reading of the intermediate master and its multiple recording areas to project the conjugate of the beam of interest onto the second recording medium can then optionally be performed in one shot by illuminating the intermediate master with the conjugates of the plurality of reference beams simultaneously. It is envisaged that the main master in this example may optionally be a broadband VPH grating comprising multiplexed holograms recorded therein and together having an optical function configured to diffract the plurality of incident beams in the desired plurality of directions towards the different recording areas.

Optionally, the first optical element is illuminated by the illumination beam from a first direction and wherein the second recording medium is illuminated by the conjugate of the illumination beam from a second direction opposite the first direction.

Optionally, the first recording medium is illuminated by the reference beam from a third direction and wherein the first recording medium is illuminated by the conjugate of the reference beam from a fourth direction opposite the third direction.

According to a second aspect of the present disclosure, there is provided a method of fabricating a hologram, the method comprising: illuminating a first optical element with an illumination beam to generate a beam of interest and noise from the first optical element, the first optical element being a master copy to be replicated; recording in a first recording medium an interference pattern between the beam of interest and a first reference beam; illuminating the recorded interference pattern in the first recording medium with a conjugate of the first reference beam to generate a conjugate of the beam of interest; and fabricating a hologram in a second recording medium by recording in the second recording medium an interference pattern between the conjugate of the beam of interest and a second reference beam.

The same advantages as described above are applicable except that in this case there is no exact replication of the master but instead the result is the fabrication of a hologram capable of generating specifically the output beam of the master (i.e. the beam of interest) as would be generated by illuminating the master by the illumination beam.

According to a third aspect of the present disclosure, there is provided a method of manufacturing a holographic combiner eyepiece for an augmented or virtual reality display, the method comprising: performing the method of any preceding claim; and laminating the replicated the first optical element onto an eyepiece of the augmented or virtual reality display.

Advantageously, an optical element (which in the case of a holographic combiner for eyepieces may be a VPH grating) replicated in this way provides a significantly less noise and thus a holographic combiner eyepiece having such a VPH grating laminated thereon is also less noisy than VPH gratings replicated using traditional methods.

### BRIEF DESCRIPTION OF THE DRAWINGS

These and other aspects will now be described, by way of example only, with reference to the accompanying figures in which:

FIG. 1a illustratively shows a known optical element recording method.

FIG. 1b illustratively shows a known optical element recording method.

FIG. 2a illustratively shows a step of an optical element recording method according to the present disclosure.

FIG. 2b illustratively shows a step of an optical element recording method according to the present disclosure.

FIG. 3a illustratively shows a step of an optical element recording method according to the present disclosure.

FIG. 3b illustratively shows a step of an optical element recording method according to the present disclosure.

FIG. 4a illustratively shows a step of an optical element recording method according to the present disclosure.

FIG. 4b illustratively shows a step of an optical element recording method according to the present disclosure.

FIG. 5a illustratively shows a step of an optical element recording method according to the present disclosure.

FIG. 5b illustratively shows a step of an optical element recording method according to the present disclosure.

FIG. 6 is a flowchart showing the steps of a method according to the present disclosure.

### DETAILED DESCRIPTION OF THE DRAWINGS

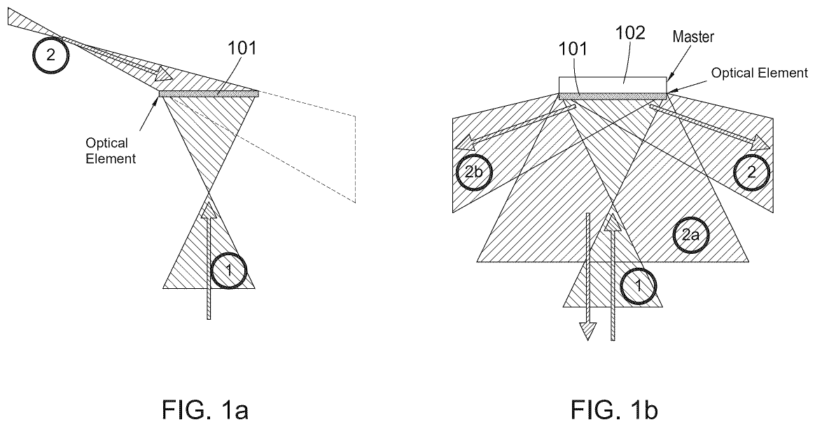

FIG. 1a illustratively shows a known optical element recording method. Like-numbered reference numerals refer to like-numbered features. A recording medium 101 is exposed to an interference pattern between an illumination beam 1 and another beam 2, for example a beam of interest diffracted from an object whose image or optical function is being recorded. Once developed into an optical element, illumination with the same illumination beam used during the recording will read out a recorded hologram.

FIG. 1b illustratively shows a known optical element recording method. The illumination beam 1 causes a master copy 102 to generate a number of beams including a beam of interest 2, and other beams 2a, 2b which are not of interest and which are considered noise. The unwanted noise, beams 2a, 2b inevitably form part of the interference pattern which is recorded in the replica optical element 101. In this known method, during the replication process, the replica 101 is laminated directly onto the master 102 and records the interference between the illumination beam 1 and the generated beams 2, 2a, 2b as well as any interference between the generated beams 2, 2a, 2b themselves. The resulting replica 101 is thus not an exact replica of the master 102 as a substantial part of the recorded interference pattern is noise.

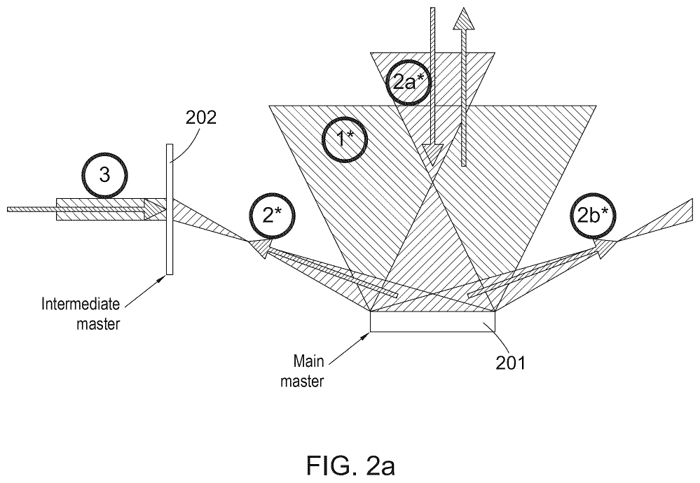

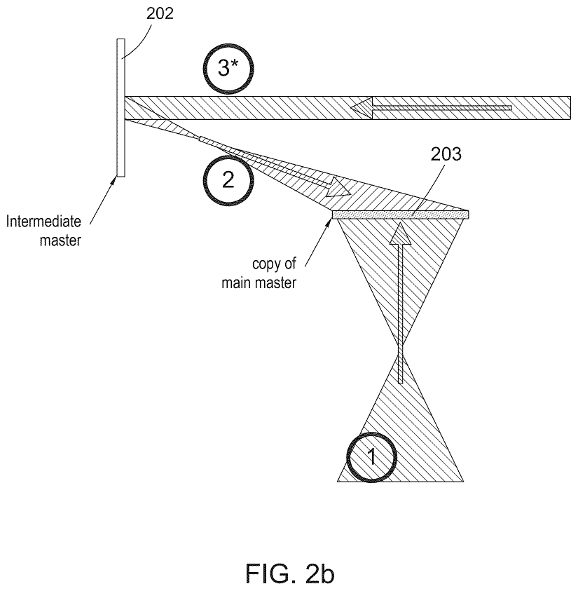

FIG. 2a illustratively shows a first step of an optical element recording method according to the present disclosure. An illumination beam 1* illuminates a first optical element 201 (i.e. master copy of the optical element that is being replicated, also referred to as the main master) which reads it out thereby generating a number of beams including a beam of interest 2*, as well as other beams 2a*, 2b* which are considered to be noise, unwanted and thus are not intended to be replicated. A first recording medium 202 that is to become an intermediate master is positioned in the optical path of only the beam of interest 2* while being illuminated with a reference beam 3. The first recording medium 202 is accordingly not in the optical paths of the unwanted, noise beams 2a*, 2b* and these accordingly do not contribute to any interference pattern and are thus not recorded in the first recording medium 202. Instead, only the interference pattern between the beam of interest 2* which intersects the first recording medium 202 and a reference beam 3 is recorded in the first recording medium 202 which thereby becomes an intermediate master. It is the intermediate master which will subsequently be used to replicate the main master as shown in FIG. 2b. As the noise beams 2a*, 2*b did not intersect the first recording medium 202, they did not become recorded in the intermediate master.

FIG. 2b illustratively shows a second step of an optical element recording method according to the present disclosure. Like-numbered reference numerals refer to like-numbered features. The first recording medium 202 which is now an intermediate master having the interference pattern between the reference beam 3 and the beam of interest 2* recorded therein is illuminated with a conjugate 3* of the reference beam i.e. a beam that is identical to the reference beam 3 in that it has the same amplitude, phases and wavelength except it has a reversed propagation direction. This causes the intermediate master to be read out and generate a conjugate 2 of the beam of interest diffracted in the direction towards where the main master 201 was originally positioned. However, in the position of the main master 201 is now instead a second recording medium 203 which is to become the replica or copy of the main master 201. Thus, the conjugate 2 of the beam of interest illuminates the second recording medium 203 which at the same time is being illuminated by a conjugate 1 of the illumination beam. An interference pattern between the conjugate 2 of the beam of interest and the conjugate 1 of the illumination beam is thereby produced and this interference pattern becomes recorded in the second recording medium 203 which thereby becomes an exact replica of the master without any contribution from unwanted noise beams 2a*, 2b*. This two-step recording process with an intermediate master is accordingly able to provide replicas which are much closer to the main master than using traditional methods.

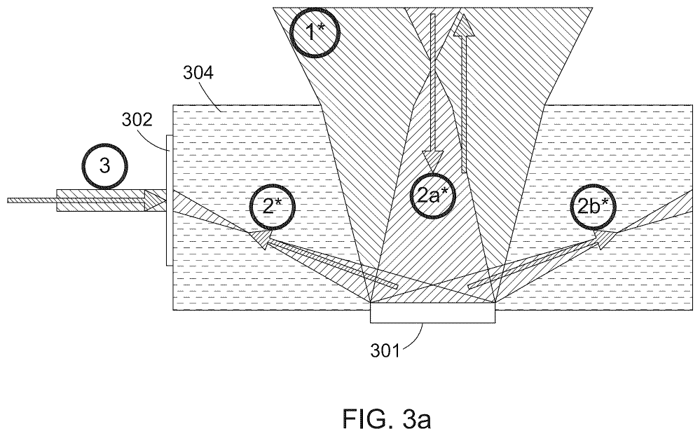

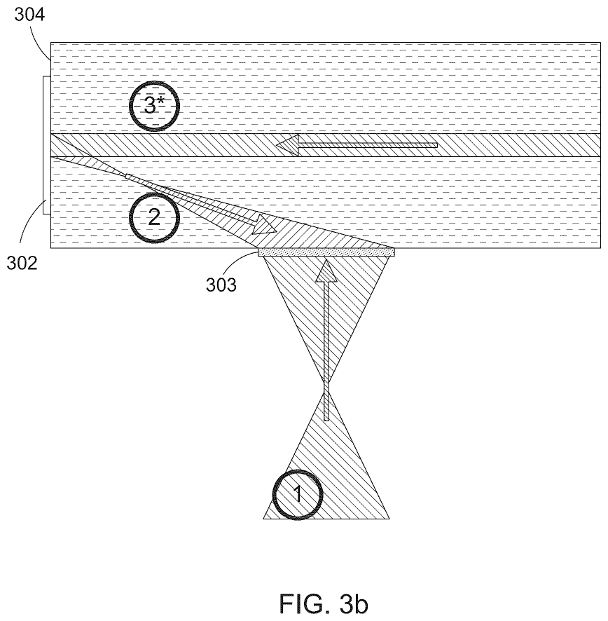

FIG. 3a illustratively shows a first step of an optical element recording method according to the present disclosure. Like-numbered reference numerals refer to like-numbered features. As in FIG. 2a, an illumination beam 1* illuminates a first optical element 301 (i.e. the master copy of the optical element that is being replicated) which reads it out thereby generating a number of beams including a beam of interest 2*, as well as other beams 2a*, 2b* which are considered to be noise, unwanted and thus are not intended to be replicated. A first recording medium 302 that is to become an intermediate master is positioned in the optical path of only the beam of interest 2* while being illuminated with a reference beam 3. The first recording medium 302 is accordingly not in the optical paths of the unwanted, noise beams 2a*, 2b* and these accordingly do not contribute to any interference pattern and are thus not recorded in the first recording medium 302. Instead, only the interference pattern between the beam of interest 2* which intersects the first recording medium 302 and a reference beam 3 is recorded in the first recording medium 302 which thereby becomes an intermediate master. It is the intermediate master which will subsequently be used to replicate the main master as shown in FIG. 3b. As the noise beams 2a*, 2*b did not intersect the first recording medium 202, they did not become recorded in the intermediate master. Additionally, illumination of the main master 301 by the illumination beam 1* takes place through a glass propagation medium 304 which has a refractive index different to free space. The main master 301 and the first recording medium 302 are positioned on outer surfaces of the propagation medium. In this way, the beam of interest 2* whose interference with the reference beam 3 is recorded in the first recording medium 302 is based on propagation through the glass block rather than through free space. When its conjugate is accordingly read out as shown in FIG. 3b and recorded on the second recording medium, it will be a recording corresponding propagation in the glass block. This is particularly useful when the replica is intended for use in applications where an incoming illumination beam used to read out the replicated optical element and the resulting generated output is diffracted immediately into a corresponding glass block. For example, when the optical element is a VPH grating that forms part of an eyepiece of a holographic combiner of an AR/VR display.

Accordingly, FIG. 3b illustratively shows a second step of an optical element recording method according to the present disclosure. Like-numbered reference numerals refer to like-numbered features. The first recording medium 302 which is now an intermediate master having the interference pattern between the reference beam 3 and the glass propagated beam of interest 2* recorded therein is illuminated with a conjugate 3* of the reference beam also provided through the glass block i.e. a beam that is identical to the reference beam 3 in that it has the same amplitude, phases and wavelength except it has a reversed propagation direction. This causes the intermediate master to be read out and generate a conjugate 2 of the beam of interest diffracted in the direction towards where the main master 301 was originally positioned. However, in the position of the main master 301 is now instead a second recording medium 303 which is to become the replica or copy of the main master 301. Thus, the conjugate 2 of the beam of interest illuminates the second recording medium 303, again through the glass block 304, which at the same time is being illuminated by a conjugate 1 of the illumination beam. An interference pattern between the conjugate 2 of the beam of interest and the conjugate 1 of the illumination beam is thereby produced and this interference pattern becomes recorded in the second recording medium 303 which thereby becomes an exact replica of the master without any contribution from unwanted noise beams 2a*, 2b*. This two-step recording process with an intermediate master is accordingly able to provide replicas which are much closer to the main master than using traditional methods with the advantage that the produced replica optical element it is particularly suitable for applications where propagation in e.g. a glass block or other such propagating medium is required.

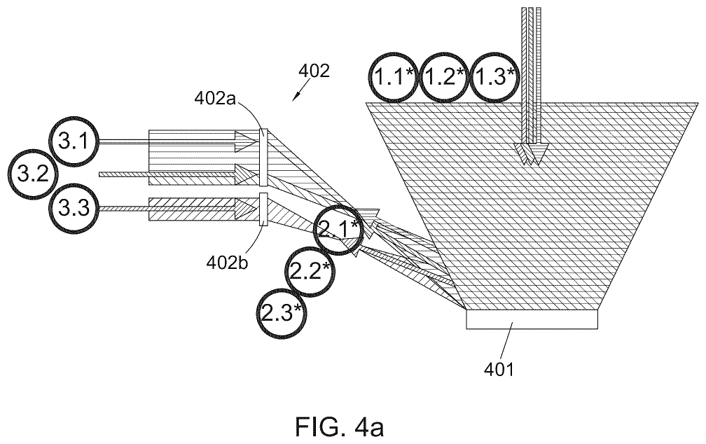

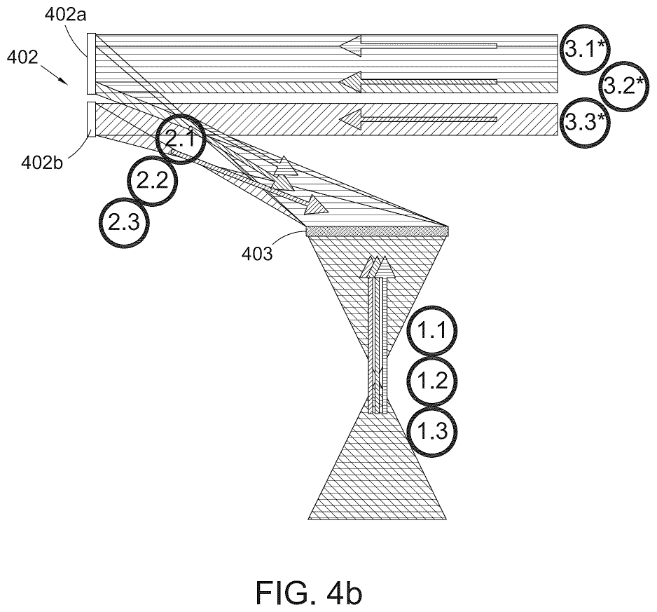

FIG. 4a illustratively shows a first step of an optical element recording method according to the present disclosure. Like-numbered reference numerals refer to like-numbered features. As in FIGS. 2a and 3a, an illumination beam 1* illuminates a first optical element 401 (i.e. the master copy of the optical element that is being replicated) which reads it out thereby generating a number of beams including a beam of interest 2*, as well as other beams (not shown to improve readability) which are considered to be noise, unwanted and thus are not intended to be replicated. However, unlike in FIGS. 2a and 3a, the illumination beam 1* of FIG. 4a comprises overlapping beams 1.1*, 1.2*, 1.3* of different wavelengths, for example wavelengths corresponding to red, green and blue colours. Each causes a corresponding beam of interest 2.1*, 2.2*, 2.3* of a different wavelength to be generated from the main master 401. Some of these may follow the same or similar or partially overlapping optical paths while others may diverge through diffraction to have a different optical path. To handle this divergence of different wavelengths, the first recording medium 402 comprises a plurality of different recording areas 402a, 402b each positioned to intersect one or more of the beams of interest 2.1*, 2.2*, 2.3*. The different recording areas 402a, 402b are illuminated by a respective reference beam 3.1, 3.2, 3.3 matching the wavelength of the incident beam of interest 2.1*, 2.2*, 2.3*. The respective interference patterns are thereby recorded on the recording areas 402a, 402b of the first recording medium. Where the beams of interest 2.1*, 2.2*, 2.3* overlap, this may accordingly result in a wavelength multiplexed recording in the intermediate master. The illumination by the different wavelengths may occur sequentially or simultaneously.

FIG. 4b illustratively shows a second step of an optical element recording method according to the present disclosure. Like-numbered reference numerals refer to like-numbered features. The first recording medium 402 and its recording areas 402a, 402b which is now an intermediate master having the interference pattern between the reference beams 3.1, 3.2, 3.3 and the beams of interest 2.1*, 2.2*, 2.3* of different wavelengths recorded therein is illuminated with conjugates 3.1*, 3.2*, 3.3* of the reference beams of different wavelengths. This causes the intermediate master to be read out and generate corresponding conjugates 2.1, 2.2, 2.3 of the beams of interest of different wavelengths diffracted in the direction towards where the main master 401 was originally positioned. However, in the position of the main master 401 is now instead a second recording medium 403 which is to become the replica or copy of the main master 401. Thus, the conjugates 2.1 2.2, 2.3 of the beams of interest of different wavelengths illuminate the second recording medium 403 which at the same time is being illuminated by the conjugate 1 of the illumination beam accordingly also comprising a plurality of beams 1.1, 1.2, 1.3 of different wavelengths matching those of the illumination beam 1*. An interference pattern between the conjugates 2.1, 2.2, 2.3 of the beams of interest of different wavelengths and the conjugate beams 1.1, 1.2, 1.3 of the illumination beam is thereby produced and this interference pattern becomes recorded in the second recording medium 403 which thereby becomes an exact replica of the master without any contribution from unwanted noise beams. This two-step recording process with an intermediate master is accordingly able to provide replicas which are much closer to the main master than using traditional methods.

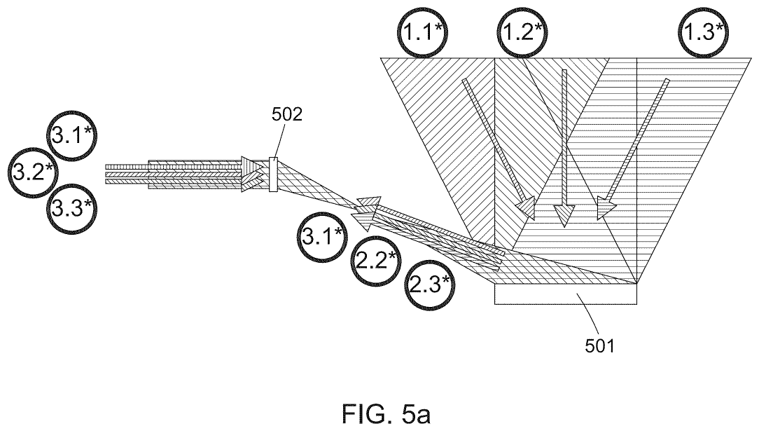

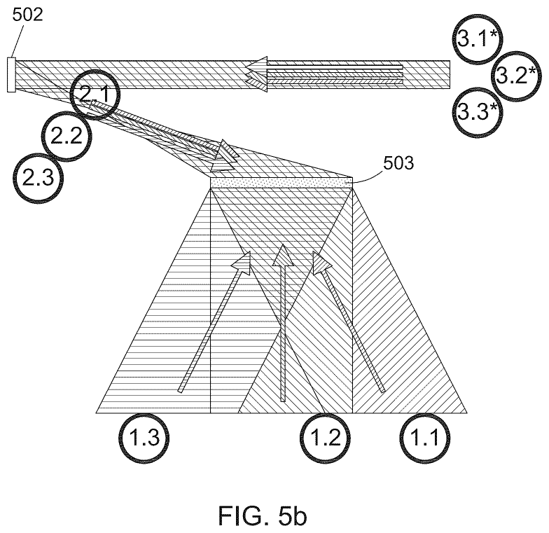

FIG. 5a illustratively shows a first step of an optical element recording method according to the present disclosure. Like-numbered reference numerals refer to like-numbered features. As in FIG. 4a, an illumination beam 1* made up of a plurality of different wavelengths illuminates a first optical element 501 (i.e. the master copy of the optical element that is being replicated) which reads it out thereby generating a number of beams of interest 2.1*, 2.2*, 2.3*, as well as other beams (not shown to improve readability) which are considered to be noise, unwanted and thus are not intended to be replicated. However, unlike in FIG. 4a, the incident beams 1.1*, 1.2*, 1.3* of different wavelengths of the illumination beam 1* of FIG. 4a are incident at different angles on the main master 501 for example to match an angle selectivity of the main master 501. This results in the generated beams of interest 2.1*, 2.2*, 2.3* having the same, overlapping optical path so that wavelength multiplexing may occur without providing the first recording medium 502 with spatially separated recording areas to intersect with diverging beams of different wavelengths. In other words, where the example of FIG. 4a handled divergence due to different wavelengths by providing a plurality of spatially separated recording areas, the example of FIG. 5a provides different beams having different angles of incidence for the illumination beams 1.1*, 1.2* 1.3* of different wavelengths so that the read out beams of interest 2.1*, 2.2*, 2.3* from the main master 501 overlap. When these interfere with reference beams 3.1, 3.2, 3.3 of corresponding wavelengths at the first recording medium 502 they are recorded in a wavelength multiplexed manner in a single recording area of the first recording medium 502. As with FIG. 4a, the illumination by the different wavelengths may occur sequentially or simultaneously.

FIG. 5b illustratively shows a second step of an optical element recording method according to the present disclosure. Like-numbered reference numerals refer to like-numbered features. The first recording medium 502 which is now an intermediate master having the interference pattern between the reference beams 3.1, 3.2, 3.3 and the beams of interest 2.1*, 2.2*, 2.3* of different wavelengths recorded therein is illuminated with conjugates 3.1*, 3.2*, 3.3* of the reference beams of different wavelengths. This causes the intermediate master to be read out and generate corresponding conjugates 2.1, 2.2, 2.3 of the beams of interest of different wavelengths diffracted in the direction towards where the main master 501 was originally positioned. However, in the position of the main master 501 is now instead a second recording medium 503 which is to become the replica or copy of the main master 501. Thus, the conjugates 2.1 2.2, 2.3 of the beams of interest of different wavelengths illuminate the second recording medium 503 which at the same time is being illuminated by the conjugate 1 of the illumination beam accordingly also comprising a plurality of beams 1.1, 1.2, 1.3 of different wavelengths at respective different angles of incidence matching those of the illumination beam 1*. An interference pattern between the conjugates 2.1, 2.2, 2.3 of the beams of interest of different wavelengths and the conjugate beams 1.1, 1.2, 1.3 of the illumination beam is thereby produced and this interference pattern becomes recorded in the second recording medium 503 which thereby becomes an exact replica of the master without any contribution from unwanted noise beams. This two-step recording process with an intermediate master is accordingly able to provide replicas which are much closer to the main master than using traditional methods.

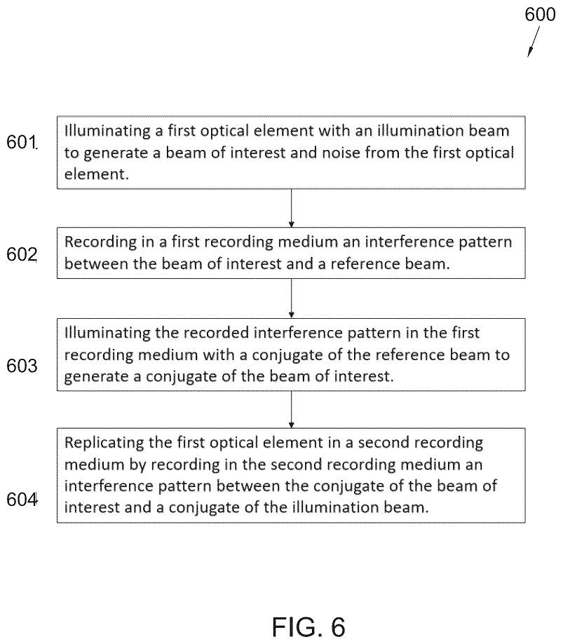

FIG. 6 is a flowchart summarising the method steps described above in connection with FIGS. 2a-5b. Accordingly, the method 600 comprises illuminating 601 a first optical element with an illumination beam to generate a beam of interest and noise from the first optical element; recording 602 in a first recording medium an interference pattern between the beam of interest and a reference beam; illuminating 603 the recorded interference pattern in the first recording medium with a conjugate of the reference beam to generate a conjugate of the beam of interest; and replicating 604 the first optical element in a second recording medium by recording in the second recording medium an interference pattern between the conjugate of the beam of interest and a conjugate of the illumination beam

Other effective alternatives will occur to the skilled person. It will be understood that the invention is not limited to the described embodiments and encompasses modifications apparent to those skilled in the art lying within the scope of the claims appended hereto.

For example, it is envisaged that the present method is intended for use in the fabrication of volume phase hologram gratings for augmented and virtual reality heads up displays such as eyewear and smart glasses such as off-axis retinal scanning displays. It may also find uses in, for example, heads up displays for vehicles. In particular, the present method finds uses in manufacturing holographic combiners for such displays.

For example, in the examples of FIGS. 4a and 4b, and FIGS. 5a and 5b, the illumination beams 1.1*, 1.2*, 1.3* and the reference beams 3.1, 3.2, 3.3 of different wavelengths may be separated, have different shapes and angles of incidence and need not be overlapping. Thus the diverging beams due to different wavelengths may be handled by a combination of using different angles of incidence of the illumination beams together with spatially separated recording areas and/or a plurality of intermediate masters. These may accordingly be independently recorded in reflection or transmission modes. The illumination beams 1.1*, 1.2*, 1.3* overlapping in FIGS. 4a and 4b, and the reference beams 3.1, 3.2, 3.3 overlapping in FIGS. 5a and 5b are accordingly exemplary only and are not intended to be limiting.

For example, the recording of the interference pattern into the first and/or second recording media may be recording in reflection or in transmission modes.

For example, as described above, optical element being replicated may be any optical element including, for example, refractive optics (for example, diffusers), mirrors, diffractive optical elements (for example, surface relief gratings or VPH gratings, metasurfaces, polarization gratings, and combinations thereof). It is envisaged that these may be in either transmission or reflective configurations. Further as described above, the present method was found to be particularly effective at replicating diffractive optical elements such as surface relief gratings, metasurfaces and polarization gratings and other diffractive optical elements in a reduced noise manner. The intermediate master produced in this way will accordingly itself be one or more of the above-described optical elements.

For example, in a further example, it is envisaged that the step of replicating the first optical element in the second recording medium by recording in the second recording medium the interference pattern between the conjugate of the beam of interest and a conjugate of the illumination beam, may be modified to replace the conjugate of the illumination with a further, second reference beam. In this case, there is no exact replication of the master but instead the result is the fabrication of a hologram capable of generating the output beam of the master (i.e. the beam of interest) illuminated by the illumination beam. In this case, it may be said that there is provided a method of fabricating a hologram, the method comprising: illuminating (601) a first optical element (201, 301, 401, 501) with an illumination beam to generate a beam of interest and noise from the first optical element, the first optical element being a master copy to be replicated; recording (602) in a first recording medium (202, 302, 402, 502) an interference pattern between the beam of interest and a first reference beam; illuminating (603) the recorded interference pattern in the first recording medium with a conjugate of the first reference beam to generate a conjugate of the beam of interest; and fabricating a hologram in a second recording medium (203, 303, 403, 503) by recording in the second recording medium an interference pattern between the conjugate of the beam of interest and a second reference beam.

List of reference numerals:

| | |
|---|---|
| 1/1* | illumination beam |
| 2* | beam of interest |
| 2 | conjugate beam of interest |
| 2a* | noise |
| 2b* | noise |
| 3 | reference beam |
| 3* | conjugate reference beam |
| 1.1*/1.2*/1.3* | illumination beams of different wavelengths |
| 1.1/1.2/1.3 | conjugate illumination beams of different wavelengths |
| 2.1*/2.2*/2.3* | beams of interest of different wavelengths |
| 2.1/2.2/2.3 | conjugate beams of interest of different wavelengths |
| 3.1/3.2/3.3 | reference beams of different wavelengths |
| 3.1*/3.2*/3.3* | conjugate reference beams of different wavelengths |
| 101 | first recording medium |
| 102 | main master |
| 201 | main master |
| 202 | first recording medium |
| 203 | second recording medium |
| 301 | main master |
| 302 | first recording medium |
| 303 | second recording medium |
| 304 | propagation medium |
| 401 | main master |
| 402 | first recording medium |
| 402a | recording area |
| 402b | recording area |
| 403 | second recording medium |
| 501 | main master |
| 502 | first recording medium |
| 503 | second recording medium |
| 600 | method according to the present |
| 601 | illuminating |
| 602 | recording |
| 603 | illuminating |
| 604 | replicating |

1. A method of replicating an optical element, the method comprising:
illuminating a first optical element with an illumination beam to generate a beam of interest and noise from the first optical element, the first optical element being a master copy to be replicated;
recording in a first recording medium an interference pattern between the beam of interest and a reference beam, wherein the first recording medium is positioned in an optical path of the beam of interest and outside an optical path of the noise;
illuminating the recorded interference pattern in the first recording medium with a conjugate of the reference beam to generate a conjugate of the beam of interest; and
replicating the first optical element in a second recording medium by recording in the second recording medium an interference pattern between the conjugate of the beam of interest and a conjugate of the illumination beam.

2. The method of claim 1, wherein the first optical element comprises a diffractive optical element.

3. The method of claim 2, wherein the diffractive optical element comprises one of a metasurface or polarisation grating.

4. (canceled)

5. The method of claim 1, wherein illuminating the first optical element and recording of the interference pattern in the first recording medium are performed in a first step, and
wherein illuminating the recorded interference pattern in the first recording medium and replicating the first optical element in the second recording medium are performed in a second step.

6. The method of claim 1, comprising positioning the first optical element at a first position during said illumination by the illumination beam; and
positioning the second recording medium at the first position during said illumination by the conjugate of the illumination beam.

7. The method of claim 1, comprising providing the first optical element, the first recording medium, and the second recording medium on one or more surfaces of a propagation medium having a refractive index different to free space.

8. The method of claim 7 wherein said illumination beam and said conjugate of the reference beam illuminate the first optical element and the first recording medium respectively by propagation through the propagation medium.

9. The method of claim 8, wherein said reference beam and said conjugate of the illumination beam illuminate the first and the second recording medium respectively without propagation through the propagation medium.

10. The method of claim 1, wherein the illumination beam, the reference beam, the beam of interest, and the conjugates thereof each comprise a plurality of beams of different wavelengths.

11. The method of claim 10, wherein each of the plurality of beams has a different angle of incidence on the first optical element, first recording medium, or second recording medium as applicable.

12. The method of claim 10, wherein illumination by said plurality of beams is provided simultaneously.

13. The method of claim 10, wherein illumination by said plurality of beams is provided sequentially.

14. The method of claim 10, wherein the first recording medium comprises a plurality of recording areas each positioned to intersect one or more of the plurality of beams of different wavelength and/or angle of incidence of the beam of interest.

15. The method of claim 1, wherein the first optical element is illuminated by the illumination beam from a first direction and wherein the second recording medium is illuminated by the conjugate of the illumination beam from a second direction opposite the first direction.

16. The method of claim 1, wherein the first recording medium is illuminated by the reference beam from a third direction and wherein the first recording medium is illuminated by the conjugate of the reference beam from a fourth direction opposite the third direction.

17. A method of fabricating a hologram, the method comprising:
illuminating a first optical element with an illumination beam to generate a beam of interest and noise from the first optical element, the first optical element being a master copy to be replicated;
recording in a first recording medium an interference pattern between the beam of interest and a first reference beam, wherein the first recording medium is positioned in an optical path of the beam of interest and outside an optical path of the noise;
illuminating the recorded interference pattern in the first recording medium with a conjugate of the first reference beam to generate a conjugate of the beam of interest; and
fabricating a hologram in a second recording medium by recording in the second recording medium an interference pattern between the conjugate of the beam of interest and a second reference beam.

18. A method of manufacturing a holographic combiner eyepiece for an augmented or virtual reality display, the method comprising:
performing the method of claim 1; and
laminating the replicated first optical element onto an eyepiece of the augmented or virtual reality display.

19. The method of claim 10, wherein each of the plurality of beams of the illumination beam has a different angle of incidence on the first optical element.

20. The method of claim 17, wherein the noise comprises unwanted beams caused by different diffraction orders, parasitic reflections and other unwanted scattering.

21. The method of claim 1, wherein the noise comprises unwanted beams caused by different diffraction orders, parasitic reflections and other unwanted scattering.
